(19) United States
(12) Patent Application Publication
(10) Pub. No.: US 2012/0225164 A1
(43) Pub. Date: Sep. 6, 2012

(54) BREWING METHOD

(75) Inventors: Anne Mette Bhatia Frederiksen, Copenhagen Oe (DK); Lars Beier, Lyngby (DK); Stefan Kreisz, Copenhagen Oe (DK)

(73) Assignee: NOVOZYMES A/S, Bagsvaerd (DK)

(21) Appl. No.: 13/509,056

(22) PCT Filed: Nov. 11, 2010
(86) PCT No.: PCT/EP10/67297

§ 371 Date: May 10, 2012

(30) Foreign Application Priority Data
Nov. 13, 2009 (EP) 09175967.0

(51) Int. Cl. C12C 1/00; C12C 5/00

(52) U.S. Cl. 426/13; 426/64

(57) ABSTRACT

A method of mashing comprising providing a grist comprising malt and adjunct; and contacting the grist with a pullulanase; an alpha amylase; and a maltogenic alpha amylase and/or a beta amylase to make a wort. An enzyme composition comprising a pullulanase; an alpha amylase; and a maltogenic alpha amylase and/or a beta amylase and the use of these enzymes in brewing is disclosed.

### REFERENCE TO SEQUENCE LISTING

This application contains a Sequence Listing in computer readable form. The computer readable form is incorporated herein by reference.

### FIELD OF THE INVENTION

This invention relates to brewing. It relates to the use of a combination of a pullulanase, an alpha amylase and a maltogenic alpha amylase and/or a beta amylase for brewing. It also relates to the use of a sucrose tolerant maltogenic alpha amylase for brewing.

### BACKGROUND OF THE INVENTION

Brewing processes are well known in the art. It involves the steps of malting, mashing and fermentation/maturation. Briefly; during malting, grains are allowed to germinate and then dried and optionally roasted. The malting process causes the activation of a number of enzymes in the grain which can convert the starch in the grain to sugar. Prior to mashing, the malt is crushed to form grist, which is mixed with water to form a mash and then sent for mashing. Mashing is the process of converting starch in the mash into fermentable and un-fermentable sugars. The mashing process is conducted over a period of time at various temperatures in order to activate the endogenous enzymes responsible for the degradation of proteins and carbohydrates. Exogenous enzymes may also added during the mashing process to speed up the reactions and enable better control over the brewing process. Towards end of mashing, the temperature may be raised to about 75° C. (165-170° F.) (known as a mashing-off). After the mashing, the resulting liquid is strained from the grains in a process known as lautering. The liquid resulting from lautering is known as wort. The wort which is rich in sugars is then boiled with hops, cooled and then fermented to ethanol using yeast. The resulting beer is conditioned for a week to several months and then packaged.

Though traditionally beer has been brewed from just barley malt, hops and water; malt is an expensive raw material because it requires superior quality grains, water for germination and energy for kilning/roasting. Traditionally around 25-30% of unmalted grains, also called adjuncts, such as maize, rice, sorghum, and wheat, refined starch or readily fermentable carbohydrates such as sugar or syrups are also included in the grist. Adjuncts are used mainly because they are readily available and provide carbohydrates at a lower cost than is available from barley malt. Other advantages may also be achieved, e.g. enhanced physical stability, superior chill-proof qualities, and greater brilliancy. However when adjuncts with higher gelatinization temperatures, for example, maize or rice are used, they must be cooked and gelatinized in a separate “cereal cooker” before being mixed into the malt mash ahead of saccharification. Thus, while the use of adjunct reduces the costs of raw material price, it requires an additional investment in the cereal cooker as well as an additional cost for energy for heating the adjunct. These additional expense requirements have discouraged brewers from increasing the adjunct ratio and also use different adjuncts of choice in their brewing process.

Of late, there is a dramatic changing in raw material prices caused by increased demand for grains, global water shortage, changing weather patterns etc. This has forced the brewing industry to focus on production efficiency as well as raw material savings.

There exists a need for improved processes in brewing which will bring down costs and/or increase production efficiency.

### SUMMARY OF THE INVENTION

The inventors have surprisingly found that a combination of a pullulanase, an alpha amylase and either a maltogenic alpha amylase or a beta amylase or both can result in improved production efficiencies. It facilitates the inclusion of a greater percentage of adjuncts during brewing; improves saccharification profile and also results in a beer that is substantially similar to a beer brewed in a traditional way.

The inventors have also surprisingly found that when such a combination is used, there is increased energy savings because the processes can be done at a lower temperature and the cereal cooking can be dispensed with.

The inventors have also surprisingly found that there is increased production efficiency and lower costs when the maltogenic alpha amylase is also sucrose tolerant.

Thus in one aspect, the invention relates to a method of mashing comprising:

a) providing a grist comprising malt and adjunct; and

b) contacting the grist with
i) a pullulanase;
ii) an alpha amylase; and
iii) a maltogenic alpha amylase and/or a beta amylase to make a wort.

In one aspect, the wort is converted into beer.

In another aspect, the invention relates to the use of a sucrose tolerant maltogenic alpha amylase in brewing.

In one aspect, the invention relates to the use of a pullulanase, an alpha amylase and a maltogenic alpha amylase and/or a beta amylase in brewing.

In another aspect, the invention relates to an enzyme composition comprising a pullulanase; an alpha amylase; and a maltogenic alpha amylase and/or a beta amylase.

In one aspect, the maltogenic amylase is a maltogenic amylase having at least 70% identity to SEQ ID NO 1.

In another aspect, the alpha amylase has at least 70% identity to SEQ ID No 2.

In one aspect, the pullulanase has at least 70% identity to SEQ ID No 3.

In one aspect, the beta amylase has at least 70% identity to SEQ ID No 4.

In another aspect, the maltogenic amylase has at least 10% more sucrose tolerance than the amylase denoted in SEQ ID NO 1.

In yet another aspect, the maltogenic amylase has at least 10% more thermo stability than the amylase denoted in SEQ ID NO 1.

In one aspect, the maltogenic amylase has substitutions at specific positions when compared to the amylase denoted in SEQ ID NO 1.

In one aspect, the pullulanase is thermostable.

In another aspect, the beta amylase is thermostable.

In one aspect, the grist comprises 30-80% malt and 30-80% adjunct.

In another aspect, the adjunct includes adjuncts which have a gelatinization temperature higher than malt starch, for example, but not limited to maize and rice.

### DETAILED DESCRIPTION OF THE INVENTION

In one aspect, the invention relates to a method of mashing comprising:
a) providing a grist comprising malt and adjunct; and
b) contacting the grist with
   i) a pullulanase;
   ii) an alpha amylase; and
   iii) a maltogenic alpha amylase and/or a beta amylase to make a wort.

The term “grist” is understood as the starch or sugar containing material that is the basis for beer production, for example, but not limited to barley malt and the adjunct.

The term “malt” is understood as any malted cereal grain, in particular, barley.

The term “starch gelatinization” is understood as the irreversible order-disorder transition that starch undergoes when heated in the presence of water. Differential Scanning calorimetry (DSC) in one technique that can be employed to study the gradual process of starch gelatinization describing the onset and peak temperature (Tₒ & Tₚ) of starch gelatinization.

The term “onset gelatinization temperature (Tₒ)” is understood as the temperature at which the gelatinization begins.

The term “peak gelatinization temperature (Tₚ)” is understood as the temperature at endotherm peak.

The term “conclusion gelatinization temperature (T_{c})” is understood as the temperature at which the gelatinization has terminated.

The term “adjunct” is understood as that part of the grist which is not malt. The adjunct may be any starch rich plant material such as, but not limited to, maize, rice, sorghum, and wheat. Preferred adjuncts for the invention include adjuncts where the starch has a higher onset, peak, and conclusion gelatinization temperature (Tₒ, Tₚ, T_{c}) than barley or malt, more preferably above 5° C. higher than malt starch. The adjuncts can be gelatinized prior to mashing or they can be added as such to the grist.

In one aspect, the adjuncts are not gelatinized prior to mashing.

The term “mash” is understood as a starch containing slurry of the grist comprising crushed barley malt, crushed unmalted grain, other starch containing material, or a combination thereof, steeped in water to make wort. “Mashing” is the process of converting starch in the mash into fermentable and un-fermentable sugars

The term “wort” is understood as the unfermented liquor run-off following extracting the grist during mashing.

A “maltogenic alpha amylase” is understood as an enzyme classified in EC 3.2.1.133. The enzymatic activity does not require a non-reducing end on the substrate and the primary enzymatic activity results in the degradation of amylopectin and amylose to maltose and longer maltodextrins. It is able to hydrolyze amylose and amylopectin to maltose in the alpha-configuration.

As used herein the term “sucrose tolerance” is understood as the % residual alpha-amylase activity of an enzyme incubated for 15 min at 60° C. in a buffer system (pH 5.0) comprising 10% sucrose. 100% sucrose tolerance is defined as the residual alpha-amylase activity of an enzyme obtained when no sucrose is added to the buffer system.

Conventional machinery, equipments and materials can be used during mashing. The grist is mixed with water prior to mashing. The water may preferably, before being added to the grist, be preheated in order for the mash to attain the desired mash temperature at the moment of mash forming. If the temperature of the formed mash is below the desired mashing temperature additional heat is preferably supplied in order to attain the desired process temperature. Preferably, the desired mashing temperature is attained within 15 minutes, or more preferably within 10 minutes, such as within 9, 8, 7, 6, 5, 4, 3, 2 minutes or even more preferably within 1 minute after the mash forming, or most preferably the desired mashing temperature is attained at the mash forming. The temperature profile of the mashing process may be a profile from a conventional mashing process wherein the temperatures are set to achieve optimal degradation of the grist dry matter by the malt enzymes.

The malt is preferably derived from one or more of the grains selected from the list comprising maize, barley, wheat, rye, sorghum, millet and rice. Preferably, the malt is barley malt.

The grist preferably comprises from 0.5% to 99%, preferably from 1% to 95%, more preferably from 5% to 90%, more preferably from 10% to 85%, even more preferably from 30% to 80% malted grain, most preferably from 30%-60% and even most preferably from 30%-50%. In addition to malted grain, the grist may preferably comprise adjunct such as unmalted maize, or other unmalted grain, such as barley, wheat, rye, oat, maize, rice, milo, millet and/or sorghum, or raw and/or refined starch and/or sugar containing material derived from plants like wheat, rye, oat, maize, rice, milo, millet, sorghum, potato, sweet potato, cassava, tapioca, sago, banana, sugar beet and/or sugar cane. The adjuncts may be obtained from tubers, roots, stems, leaves, legumes, cereals and/or whole grain. Preferred is adjunct obtained from maize and/or rice, more preferred the adjunct is maize. The mash preferably comprises from 1% to 80%, preferably from 5% to 80%, more preferably from 10% to 80%, and even more preferably from 30 to 80% adjunct starch, most preferably from 30-60% and even most preferably from 40-60%.

Preferably these adjuncts have high gelatinization temperature. More particularly, these adjuncts have a high onset gelatinization temperature.

In one aspect of the invention, the adjunct is a mixture comprising both high and low gelatinization temperature adjuncts.

When an aqueous solution of starch granules is heated, the granules swell to form a paste. This process is called “gelatinization”. The temperature at which gelatinization occurs is called the “gelatinization temperature”. Because of the complex nature of the starch in the adjuncts and also the conditions during mashing, the gelatinization actually occurs over a particular temperature range. The gelatinization temperature range thus can be characterised by the “onset gelatinization temperature”, the “peak gelatinization temperature” and the “conclusion gelatinization temperature”. For example, for corn starch, the onset gelatinization temperature is approximately 62° C. (peak: 67° C., conclusion: 72° C.), and for rice starch the onset gelatinization temperature is approximately 68° C. (peak: 74.5° C., conclusion: 78° C.) (Starch, 2nd ed. Industrial microscopy of starch by Eileen Maywald Snyder). The initial gelatinization temperature may vary according to the plant species, to the particular variety of the plant species as well as with the growth conditions.

Adjunct may also comprise readily fermentable carbohydrates such as sugars or syrups and they may be added to the malt mash before, during or after the mashing process of the invention but is preferably added after the mashing process.

Prior to forming the mash, the malt and/or adjunct is preferably milled and most preferably dry or wet milled.

The enzymes may be added as enzyme compositions. They may consist of one enzyme or more than one enzyme or more than one enzyme compositions. The enzyme composition, in addition to the enzyme(s), may also contain at least one other substance, for example but not limited to buffer, surfactants etc. The enzyme compositions may be in any art-recognized form, for example, solid, liquid, emulsion, gel, or paste. Such forms are known to the person skilled in the art. In one aspect of the invention more than one enzyme composition, each containing different enzymes may be added. In another aspect of the invention, one enzyme composition containing all the necessary enzymes may be added. In yet another aspect of the invention, one enzyme composition containing a few of the enzymes and at least one another composition containing some or all of the rest of the enzymes may be added

In one aspect of the invention, an enzyme composition comprising an alpha amylase, a pullulanase, a maltogenic alpha amylase and/or a beta amylase is exogenously supplied and may be added to the mash ingredients, e.g. the water or the grist before during or after forming the mash, or at any time during the mashing.

During the mashing process, starch extracted from the grist is gradually hydrolyzed into fermentable sugars and smaller dextrins. Preferably the mash is starch negative to iodine testing, before extracting the wort. The mashing is finalized by mashing-off at temperature of 70° C. or more, preferably at least 71° C., at least 72° C., at least 73° C., at least 74° C., at least 75° C., at least 76° C. at least 77° C., at least 78° C., least 79° C., at least 80° C. and more preferably at least 81° C. or even at least 82° C. or more.

Obtaining the wort from the mash typically includes straining the wort from the spent grains, i.e. the insoluble grain and husk material forming part of grist. Hot water may be run through the spent grains to rinse out, or sparge, any remaining extract from the grist. Preferably, the extract recovery is at least 80%, preferably at least 85%, at least 90%,. The wort may be used as it is, or it may be concentrated and/or dried.

The wort may also be processed to be used as syrups. It may also be used to produce non alcoholic beverages. These processes are known to a person skilled in the art.

The wort may also be fermented to beer. Preferred beer types comprise ales, strong ales, stouts, porters, lagers, bitters, export beers, malt liquors, happoushu, high-alcohol beer, low-alcohol beer, low-calorie beer or light beer. Fermentation of the wort may also include pitching the wort with a yeast slurry comprising fresh yeast, i.e. yeast not previously used for the invention or the yeast may be recycled yeast. The yeast applied may be any yeast suitable for beer brewing, especially yeasts selected from Saccharomyces spp. such as S. cerevisiae and S. uvarum, including natural or artificially produced variants of these organisms. The methods for fermentation of wort for production of beer are well known to the person skilled in the art. Silica hydrogel may be added to the fermented wort to increase the colloidal stability of the beer. The process may further include adding kieselguhr to the fermented wort and filtering to render the beer bright.

### Enzymes

### Maltogenic Alpha Amylase (EC 3.2.1.133)

The maltogenic alpha-amylase is an enzyme classified in EC 3.2.1.133. The enzymatic activity does not require a non-reducing end on the substrate and the primary enzymatic activity results in the degradation of amylopectin and amylose to maltose and longer maltodextrins. It is able to hydrolyze amylose and amylopectin to maltose in the alpha-configuration.

Examples of maltogenic amylases include but not limited to the amylase Novamyl® available from Novozymes A/S.

A particularly preferred maltogenic alpha-amylase is the maltogenic amylase of Seq ID No 1.

In one aspect of the invention the maltogenic alpha amylase has at least 70% identity, such such as at least 75%, such as at least 80%, such as at least 85%, such as at least 86%, such as at least 87%, such as at least 88%, such as at least 89%, such as at least 90%, such as at least 91%, such as at least 92%, such as at least 93%, such as at least 94%, such as at least 95%, such as at least 96%, such as at least 97%, such as at least 98%, such as at least 99% or even 100% identity to the sequence shown in SEQ ID No 1.

The term “identity” is the relatedness between two amino acid sequences or between two nucleotide sequences. For purposes of the present invention, the degree of identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends in Genetics 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

In one aspect, the maltogenic alpha amylase has amino acid mutations at one or more specific positions in Seq ID. No 1. For example, the mutations may be at least at one or more positions Y89F, P191S, D261G, T288P, W93F, F194Y, Y360F or Y360 N. The nomenclature used herein for defining mutations is essentially as described in WO 92/05249. Thus, Y89F indicates a substitution of the amino acid Y (Tyr) in position 89 with the amino acid F (Phe). The methods for making these mutations are known to a person skilled in the art.

In one aspect the maltogenic alpha amylase has mutations at Y89F, P191S, D261G and T288P.

In another aspect, the maltogenic alpha amylase has additional mutations at least at W93F, F194Y, Y360F or Y360N.

In one aspect the maltogenic alpha amylase has mutations at Y89F, W93F, P191S, D261 G and T288P.

In another aspect the maltogenic alpha amylase has mutations at Y89F, P191S, F194Y, D261 G and T288P.

In one aspect the maltogenic alpha amylase has mutations at Y89F, P191S, D261G, T288P and Y360F.

In another aspect the maltogenic alpha amylase has mutations at Y89F, P191S, D261 G, T288P and Y360N.

In one aspect, the maltogenic alpha amylase has at least 10% such as at least 15% such as at least 20% such as at least 25% or such as at least 30% or at least 35% or at least 40% or at least 45% or at least 50% or at least 55% or at least 60% or at least 65% or at least 70% or at least 75% more sucrose tolerance than the maltogenic alpha amylase of Seq ID No. 1.

The sucrose tolerance is determined using the method given in Example 5.

In one aspect, the maltogenic alpha amylase is thermostable.

In another aspect, the maltogenic alpha amylase has at least 10% or at least 15% or at least 20% or at least 25% or at least 30%or at least 35% or at least 40% or at least 45% or at least 50% or at least 55% or at least 60% or at least 65% or at least 70% or at least 75% more thermo stability than the maltogenic alpha amylase of Seq ID No. 1.

Thermostability of an enzyme is the capacity of the enzyme to resist irreversible thermal inactivation. For maltogenic amylase, it is determined by finding the amount of activity of the enzyme that remains after incubating the enzyme in a buffer (pH6) for 10 minutes both at 25° C. and at 72° C.

The maltogenic alpha amylase may be included in the range of 1-30, preferably 2-25, more preferably 5-20, or most preferably 8-13 MANU/g dry matter of the adjunct.

One Maltogenic Amylase Novo Unit (MANU) is the amount of enzyme which under standard will cleave one pmol maltotriose per minute. The standard conditions are 10 mg/ml maltotriose, 37° C., pH 5.0, 30 minutes reaction time.

### Alpha-Amylase (EC 3.2.1.1)

An alpha-amylase enzyme may also be exogenous, microbial and added to the processes and/or compositions of the invention. The alpha-amylase may be a Bacillus alpha-amylase. Well-known Bacillus alpha-amylases include alpha-amylase derived from a strain of B. licheniformis, B. amyloliquefaciens, and B.stearothermophilus. A preferable alpha amylase is an alpha-amylase from B. stearothermophilus having the amino acid sequence disclosed as SEQ ID NO: 3 in WO 99/19467 with the mutations: I181*+G182* +N193F.

In one aspect, the alpha amylase is an alpha amylase of Seq ID No.2.

In one aspect of the invention the alpha amylase has at least 70% identity, such as at least 75%, such as at least 80%, such as at least 85%, such as at least 86%, such as at least 87%, such as at least 88%, such as at least 89%, such as at least 90%, such as at least 91%, such as at least 92%, such as at least 93%, such as at least 94%, such as at least 95%, such as at least 96%, such as at least 97%, such as at least 98%, such as at least 99% or even 100% identity to the sequence shown in SEQ ID No 2.

The alpha amylase may be added in the range of 0.001 to 10 KNU, preferably 0.01 to 5 KNU, even more preferably between 0.1 to 2 KNU per gram of dry matter of the adjunct.

One Kilo Novo alpha amylase Unit (KNU) equals 1000 NU. One KNU is defined as the amount of enzyme which, under standard conditions (i.e. at 37° C.+/−0.05; 0.0003 M Ca2+; and pH 5.6) dextrinizes 5.26 g starch dry substance Merck Amylum solubile.

### Pullulanase (E.C. 3.2.1.41)

The pullulanases used in the processes according to the present invention is preferably pullulanase from e.g. Pyrococcus or Bacillus sp, such as Bacillus acidopullulyticus (e.g., the one described in FEMS Microbiol. Letters 115: 97-106) or Bacillus deramificans, or Bacillus naganoencis. The pullulanase may also be an engineered pullulanases from, e.g., a Bacillus strain.

Other pullulanases which is preferably used in the processes according to the invention includes: Bacillus deramificans (U.S. Pat. No. 5,736,375), or the pullulanase may be derived from Pyrococcus Woesei described in PCT/DK91/00219, or the pullulanase may be derived from Fervidobacterium sp. Ven 5 described in PCT/DK92/00079, or the pullulanase may be derived from Thermococcus celer described in PCT/DK95/00097, or the pullulanase may be derived from Pyrodictium abyssei described in PCT/DK95/00211, or the pullulanase may be derived from Fervidobacterium pennavorans described in PCT/DK95/00095, or the pullulanase may be derived from Desulforococcus mucosus described in PCT/DK95/00098.

Most preferably the pullulanase is derived from Bacillus acidopullulyticus.

A preferred pullulanase enzyme to be used in the processes and/or compositions of the invention is a pullulanase having an amino acid sequence of Seq ID No.3.

In one aspect of the invention the pullulanase has at least 70%, such as at least 75%, such as at least 80%, such as at least 85%, such as at least 86%, such as at least 87%, such as at least 88%, such as at least 89%, such as at least 90%, such as at least 91%, such as at least 92%, such as at least 93%, such as at least 94%, such as at least 95%, such as at least 96%, such as at least 97%, such as at least 98%, such as at least 99% or even 100% identical to the sequence shown in Seq ID No: 3.

In one aspect of the invention, the pullulanase is thermostable. An example of such a pullulanase is a pullulanase described in WO2009075682.

For pullulanase, the thermostability is determined by finding the amount of activity of the enzyme that remains after incubating the enzyme in a buffer (pH 5) for 10 minutes both at 25° C. and at 64° C.

The pullulanase is added in dosage of 0.1 to 3 PUN/g dry matter (DM) adjunct, such as 0.2 to 2.9, such as 0.3 to 2.8, such as 0.3 to 2.7 such as 0.3 to 2.6 such as 0.3 to 2.5 such as 0.3 to 2.4, such as 0.3 to 2.3, such as 0.3 to 2.2, such as 0.3 to 2.1, such as 0.3 to 2.0, such as 0.3 to 1.9, such as 0.3 to 1.8, such as 0.3 to 1.7, such as 0.3 to 1.6, most preferably pullulanase is added in dosage such as 0.3 to 1.5, preferably 0.4 to 1.4, more preferably 0.5 to 1.3, more pre- ferably 0.6 to 1.2, more preferably 0.7 to 1.1, more preferably 0.8 to 1.0, more preferably 0.9 to 1.0. In a particular embodiments of the invention the enzyme is added in 0.3 PUN/g DM adjunct, such as 0.4 PUN/g DM adjunct, such as 0.5 PUN/g DM adjunct, such as 0.6 PUN/g DM adjunct, such as 0.7 PUN/g DM adjunct. In a particularly preferred embodiment of the invention the enzymes dose is not larger than 1 PUN/g DM adjunct.

One pullulanase unit (PUN) is the amount of enzyme which, under standard conditions (i.e. after 30 minutes reaction time at 40° C. and pH 5.0; and with 0.2% pullulan as substrate) hydrolyzes pullulan, liberating reducing carbohydrate with a reducing power equivalent to 1 micromol glucose per minute.

Pullulanase activity is by measured by detection of increased reducing sugar capacity (Somogyi-Nelson reaction) in the following conditions: Substrate: 0.2% pullulan, pH 5.0, reaction time 30 minutes.The samples are analyzed by spectrophotometer at OD 520 nm.

### Beta Amylase (E.C 3.2.1.2)

Beta-amylase is the name traditionally given to exo-acting maltogenic amylases, which catalyze the hydrolysis of 1,4-alpha-glucosidic linkages in amylose, amylopectin and related glucose polymers.

Beta-amylases have been isolated from various plants and microorganisms (W. M. Fogarty and C. T. Kelly, 1979, Progress in Industrial Microbiology, 15: 112-115). These beta-amylases are characterized by having optimum temperatures in the range from 40 degree C. to 65. degree C. and optimum pH in the range from 4.5 to 7.0. Contemplated beta-amylases include the beta-amylase from barley Spezyme® BBA 1500, Spezyme® DBA and Optimalt™ ME, Optimalt™ BBA from Genencor Int. as well as Novozym™ WBA from Novozymes A/S.

Beta amylases are generally included in the range of 1 to 25 BAMU/g DM adjunct, such as from 1 to 20 BAMU/g DM adjunct, such as from 1 to 15 BAMU/g DM adjunct, such as from 1 to 10

BAMU/g DM adjunct, such as from 2 to 7 BAMU/g DM adjunct, such as from 2 to 6 BAMU/g DM adjunct, such as from 4 to 6 BAMU/g DM adjunct.

A beta-amylase unit (BAMU) is defined as the amount of enzyme that degrades one pmol maltohexaose per minute under the following conditions (37° C., pH 5.5, 200 sec incubation, 0.856 mM maltothexaose substrate, Sufficient activity of a maltose oxidizing enzyme releasing H₂O₂ e.g.4.8 LOXU/mL lactose oxidase, 1.7 mM 4-aminoantipyrine (AA), 4.3 mM N-Ethyl-N-sulfopropyl-m-toluidine (TOPS), 2.1 U/mL peroxidise (Sigma).

Beta Amylase acts on the non-reducing end of maltohexaose (G6) to form maltose (G2) and maltotetraose (G4), the hydrolysis is measured with a method quantifying reducing end, such as the use of carbohydrate or lactose-oxidase and O₂ to form H₂O₂. The formed H₂O₂ activates in the presence of peroxidase the oxidative condensation of 4-aminoantipyrine (AA) and N-ethyl-N-sulfopropyl-m-toluidine (TOPS), to form a purple product which can be quantified by its absorbance at 540 nm. The reaction is initiated by maltohexaose (G6). When all components but beta amylase are in surplus, the rate of the rising absorbance is proportional to the beta amylase activity present.

In one aspect, the beta amylase is thermostable. An example of a thermostable beta amylase is the beta amylase from Clostridium thermosulfurogenes. An example of such a beta amylase is found in Kitamoto et al., 1988, J. Bacteriol, 170 (12) 5848-5854.

In one aspect, the beta amylase is a beta amylase having an amino acid sequence of Seq ID No 4.

In one aspect of the invention the beta amylase has at least 70% identity, such as at least 75%, such as at least 80%, such as at least 85%, such as at least 86%, such as at least 87%, such as at least 88%, such as at least 89%, such as at least 90%, such as at least 91%, such as at least 92%, such as at least 93%, such as at least 94%, such as at least 95%, such as at least 96%, such as at least 97%, such as at least 98%, such as at least 99% or even 100% identity to the sequence shown in SEQ ID No 4.

### EXAMPLES

### Example 1

The objective of this example is to demonstrate the benefit of having all 3 enzymes (pullulanase, maltogenic alpha-amylase and an alpha amylase) present during mashing than only having 2 of them in different combinations and dosages.

A grist comprising 50% non-pre gelatinized maize grits and 50% well modified (WM) malt was ground (0.2 mm gap in a disc mill) and mashed in the presence of a pullulanase of Seq ID No. 3, an alpha-amylase of Seq ID No. 2, and a maltogenic alpha-amylase of Seq ID No.1. Maize and malt was mashed-in at a ratio of 1:5 (normal gravity) and the mashing temperature profile consisted of mashing-in at 52° C. for 30 min, increase to 62° C. (1° C./min), hold at 62° C. for 30 min, increase to 72° C. (1° C./min), hold at 72° C. for 30 min, increase to 78° C. (1° C./min) followed by immediate cooling to 20° C. (total mashing time of 131 minutes). The wort and fermented wort (one day lab. fermentation at room temperature) were analyzed by HPLC (sugar profile) and Anton Paar (% Real Degree of Fermentation, RDF and Extract, Ea). The following enzyme activities were dosed in all different combinations: 0 or 0.7 PUN pullulanase, 0 or 0.5 KNU alpha-amylase and 0 or 11.0 MANU maltogenic alpha-amylase per g Dry Matter adjunct.

All results are summarized in Table 1.

TABLE 1

| Units/g DM adjunct | % DP4+ (Δ%) | % RDF (Δ%) |
|---|---|---|
| No enzymes dosed (control) | 31.7 | 57.0 |
| 0.5 KNU | 28.6 (Δ 3.1) | 59.9 (Δ 2.9) |
| 0.5 KNU + 11 MANU | 22.2 (Δ 9.5) | 65.9 (Δ 8.9) |
| 0.5 KNU + 0.7 PUN | 26.7 (Δ 5.0) | 61.4 (Δ 4.4) |
| 11 MANU + 0.7 PUN | 21.2 (Δ 10.5) | 67.6 (Δ 10.6) |
| 0.5 KNU + 0.7 PUN + 11 MANU | 20.0 (Δ 11.7) | 68.6 (Δ 11.6) |

The above data shows that the combination of an alpha amylase, a pullulanase and a maltogenic alpha amylase results in better wort characteristics than the use of the enzymes alone in single or in dual combinations.

### Example 2

The objective was to assess the temperature optimum of beta-amylase from Clostridium thermosulfurogenes.

Temperature optimum of beta-amylase of Seq ID No. 4 obtainable from Clostridium thermosulfurogenes was determined by the release of maltose from amylopectin measuring the reducing ends by PHABH reagent. 1 mL substrate (1% w/v potato amylopectin in 50 mM NaOAc, 1 mM CaCl2, pH 4.5) was pre-incubated at 60° C. for 10 minutes. As a control 150 μL was withdrawn prior to enzyme addition and mixed with 75 μL stop reagent (0.75 g PHABH (Sigma), 2.5 g K—Na-tartrate (Merck) and 50 ml 2% NaOH). For enzyme incubations, 150 μL enzyme solution was added to the substrate and incubated for 10 min at 30, 40, 50, 60, 70, or 80° C. 75 μL stop reagent was added and the solution was incubated at 100° C. for 15 min. 200 μL was transferred to PCR-tubes and absorbance measured at 410 nm. The experiment was carried out in triplicate. The pH optimum of beta-amylase from Clostridium thermosulfurogenes was determined according to the above procedure with the following modifications. Incubation was carried out at 60° C. at pH 4, 5, 6, 7, 8 or 9.

TABLE 2
Temperature optimum

| ° C. | Abs410 |
|---|---|
| 30 | 0.255 |
| 40 | 0.325 |
| 50 | 0.329 |
| 60 | 0.414 |
| 70 | 0.470 |
| 80 | 0.471 |

TABLE 3
pH optimum

| pH | Abs410 |
|---|---|
| 4 | 0.402 |
| 5 | 0.524 |
| 6 | 0.631 |
| 7 | 0.595 |
| 8 | 0.354 |
| 9 | 0.140 |

The beta-amylase from Clostridium thermosulfurogenes has temperature optimum at 70-80° C. and pH optimum around pH 5-7 (Table 2 and 3). In comparison, barley beta-amylase has temperature optimum at 60-65° C. at mash conditions (pH 5.8) (Kunze (1999), Technology Brewing and Malting, VLB Verlag, Berlin).

### Example 3

The objective of this example was to demonstrate the benefit of having a thermostable beta-amylase present during mashing and lautering in combination with a pullulanase and alpha-amylase.

A grist comprising 50% non-pre gelatinized maize grits and 50% well modified (WM) malt was grinded (0.2 mm gap in a disc mill) was mashed in the presence of a pullulanase of Seq ID No.3, a alpha-amylase of Seq ID No 2 and beta amylase of Seq ID No. 4. Maize and malt was mashed-in at a ratio of 1:5 (normal gravity) and the mashing temperature profile consisted of mashin-in at 52° C. for 30 min, increase to 62° C. (1° C./min), hold at 62° C. for 30 min, increase to 72° C. (1° C./min), hold at 72° C. for 30 min, increase to 78° C. (1° C./min) followed by incubation for 2 hours at 78° C. (simulated lautering) followed by immediate cooling to 20° C. The wort and fermented wort (one day lab fermentation at room temperature) were analyzed by HPLC (sugar profile) and Anton Paar (% Real Degree of Fermentation, RDF and Extract, Ea). The following enzyme activities were dosed in all different combinations: 0 or 0.7 PUN pullulanase, 0, 0.15 KNU alpha-amylase and 0 or 2.5 BAMU beta-amylase per g Dry Matter adjunct. The results are given in Table 4 below:

TABLE 4
Wort sugar profile (% of total sugars) and % RDF (Real Degree of
Fermentation) in the fermented wort. Pullulanase (PUN),
alpha-amylase (KNU), beta-amylase (BAMU).

| Enzyme dosage | | | | |
|---|---|---|---|---|
| (Units/g DM adjunct) | | | | |
| PUN | KNU | BAMU | % DP4+ | % RDF |
| — | — | — | 26.6 | 57.4 |
| 0.7 | — | — | 23.3 | 60.0 |
| 0.7 | 0.15 | — | 20.8 | 62.6 |
| 0.7 | 0.15 | 2.5 | 14.2 | 69.8 |

Table 4 demonstrates the benefit of having a thermostable beta-amylase present during mashing in combination with a pullulanase and alpha-amylase. A markedly higher level of maltose was obtained resulting in a lower level of non-fermentable sugars (DP4+) and correspondingly a higher % RDF of the fermented wort.

### Example 4

A grist comprising 50% non-pre gelatinized maize grits and 50% well modified (WM) malt was grinded (0.2 mm gap in a disc mill) and mashed in the presence of a maltogenic alpha-amylase of Seq ID No. 1, an alpha-amylase of Seq ID No. 2, and a Pullulanase of Seq ID No.3. Maize and malt was mashed-in at a ratio of 1:3 (high gravity) and the mashing temperature profile consisted of mashing-in at 52° C. for 30 min, increase to 62° C. (1° C./min), hold at 62° C. for 30 min, increase to 72° C. (1° C./min), hold at 72° C. for 30 min, increase to 78° C. (1° C./min) and then immediately cooling to 20° C. (3.9° C./min) resulting in a total mashing time of 131 minutes. The wort and fermented wort (one day lab fermentation at room temperature) were analyzed by HPLC (sugar profile) and Anton Paar (% Real Degree of Fermentation, RDF and Extract, Ea). The following enzyme activities were dosed: 0.7 PUN pullulanase, 0.5 KNU alpha-amylase and 11.0 MANU maltogenic alpha-amylase per gram of dry matter adjunct.

Results are summarized in Table 5, demonstrating that the combination of a maltogenic amylase, an alpha amylase and a pullulanase results in improvement in starch hydrolysis, maltose formation and % RDF.

TABLE 5
Enzyme dosage, wort sugar profile (% of total sugar), wort extract
level (g/100 mL) and % RDF obtained for the 4 enzyme variants
in comparison to the wild type.

| Maltogenic | | | | | | |
|---|---|---|---|---|---|---|
| alpha- | % | % | | | Extract | |
| amylase | DP1 | DP2 | % DP3 | % DP4+ | (g/100 mL) | % RDF |
| Seq ID No 1 | 16.7 | 42.1 | 14.8 | 25.1 | 20.6 | 65.4 |
| Variant 1 | 18.7 | 43.6 | 13.4 | 23.3 | 20.6 | 70.3 |
| Variant 2 | 20.6 | 45.3 | 13.5 | 19.4 | 20.6 | 69.8 |
| Variant 3 | 18.4 | 43.5 | 14.0 | 22.9 | 20.7 | 67.1 |
| Variant 4 | 18.3 | 43.3 | 14.3 | 22.9 | 20.6 | 67.4 |

The variants are defined in example 5, table 6 below.

The terms “DP1” (Degree of polymerization 1) denotes glucose, “DP2” denotes maltose and DP3 denotes maltotriose. The terms “DP4+” or “DP4/4+” denote dextrin, or maltooligosaccharides of a polymerization degree of 4 or higher.

The term “RDF” means real degree of fermentation. RDF (Real degree of fermentation) is calculated as % RDF=100*(OE% P−ER%)/OE% P whereas OE means Original Extract in % P and ER means Real Extract % P measured by a densitometer (Analytica EBC reference). RDF: Real Degree of Fermentation, was determined by the method described in MEBAK method: 2.9.2. Principal: Reduction of wort dry matter, in %, by fermentation to alcohol and CO2.

The table above demonstrates that the variants give a higher RDF than the enzyme of Seq ID No 1. Among the variants, variant 2 appears to be the best.

### Example 5

Sucrose tolerance of 4 maltogenic alpha-amylase variants was studied.

Sucrose tolerance was determined by incubating the given enzyme in a buffer (pH 5.0) containing 10% sucrose (% w/v) for 15 minutes at 60° C. Immediately after incubation the residual activity of the enzyme was determined by the Phadebas assay (endo alpha-amylase activity). 100% sucrose tolerance corresponds to the residual activity obtained of the maltogenic alpha-amylase when no sucrose is present in the incubation buffer.

Results are summarized in Table 6 demonstrating that the 4 maltogenic alpha-amylase variants are more sucrose tolerant than the wild type.

TABLE 6
Amino acid modifications and sucrose tolerance of maltogenic
alpha-amylase enzyme variants in comparison to the wild type.

| Maltogenic | | |
|---|---|---|
| alpha- | | % sucrose |
| amylase | Amino acid modifications | tolerance. |
| Seq ID No 1. | — | 12 |
| Variant 1 | Y89F, W93F, P191S, D261G, T288P | 70 |
| Variant 2 | Y89F, P191S, F194Y, D261G, T288P | 53 |
| Variant 3 | Y89F, P191S, D261G, T288P, Y360F | 40 |
| Variant 4 | Y89F, P191S, D261G, T288P, Y360N | 40 |

From the table, it is apparent that variant 1 is 58%, variant 2 is 41% and variant 3 and 4 are 28% more sucrose tolerant that Seq ID No.1 respectively.

1. A method of mashing comprising:
a) providing a grist comprising malt and adjunct; and
b) contacting the grist with
i) a pullulanase;
ii) an alpha amylase; and
iii) a maltogenic alpha amylase and/or a beta amylase to make a wort.

2. The method according to claim 1, wherein the adjunct has a gelatinization temperature higher than the malt starch.

3. The method according to claim 1, wherein the adjunct is maize or rice.

4. The method according to claim 1, wherein the maltogenic alpha amylase has at least 70% identity to SEQ ID No 1.

5. The method according to claim 1, wherein the alpha amylase has at least 70% identity to SEQ ID No 2.

6. The method according to claim 1, wherein the pullulanase has at least 70% identity to SEQ ID No 3.

7. The method according to claim 1, wherein the beta amylase has at least 70% identity to SEQ ID No 4.

8. The method according to claim 1, wherein the pullulanase is thermostable wherein the thermostability is measured by finding the amount of activity of the enzyme that remains after incubating the enzyme in a buffer at pH 5.0 for 10 minutes both at 25° C. and at 64° C.

9. The method according to claim 1, wherein the maltogenic alpha amylase is at least 10% more sucrose tolerant than SEQ ID No 1 wherein the sucrose tolerance is measured in a buffer containing 10% sucrose (%w/v) at pH 5.0 for 15 minutes at 60° C. in accordance with example 5.

10. The method according to claim 1 wherein the beta amylase has a temperature optimum of 70-80° C. wherein the temperature optimum is measured in accordance to example 2.

11. The method according to claim 4, wherein the maltogenic alpha amylase comprises the substitutions at positions Y89F, P191S, D261 G and T288P in SEQ ID No 1.

12. The method according to claim 4, wherein the maltogenic alpha amylase comprises one or more of the substitutions W93F, Y360F, Y360N and F194Yin SEQ ID No 1.

13. The method according to claim 1, wherein the grist comprises 30-80% malt and 30-80% adjunct.

14. The method according to claim 1, wherein the wort is converted to beer.

15. Use of a pullulanase, an alpha amylase and a maltogenic alpha amylase and/or a thermostable beta amylase in brewing.

16. An enzyme composition comprising
a. a pullulanase;
b. an alpha amylase; and
c. a thermostable beta amylase.

17. An enzyme composition comprising
a. a thermostable pullulanase;
b. an alpha amylase; and
c. a beta amylase.


SEQUENCE LISTING (4 sequences)

SEQ ID NO: 1 - protein, 685 aa, Bacillus stearothermophilus
ASSSASVKGDVIYQIIIDRFYDGDTTNNNPAKSYGLYDPTKSKWKMYWGGDLEGVRQKLPYLKQLGVTTIWLSPVLNNLDTLAGTDNTGYHGYWTRDFKQIEEHFGNWTTFDTLVNDAHQNGIKVIVDFVPNHSTPFKANDSTFAEGGALYNNGTYMGNYFDDATKGYFHHNGDISNWDDRYEAQWKNFTDPAGFSLADLSQENGTIAQYLTDAAVQLVAHGLRIDAVKHFNSGFSKSLADKLYQKKDIFLVGEWYGDDPGTANHLEKVRYANNSGVNVLDFDLNTVIRNVFGTFTQTMYDLNNMVNQTGNEYKYKENLITFIDNHDMSRFLSVNSKNKANLHQRLLSFSLRGVRPPIYYGTEQYMAGGNDPYNRGMMPAFDTTTTAFKEVSTLAGLRRNNAAIQYGTTTQRWINNDVYIYERKFFNDVVLVAINRNTQSSYSISGLQTALPNGSYADYLSGLLGGNGISVSNGSVASFTLAPGAVSVWQYSTSASAPQIGSVAPNMGIPGNVVTIDGKGFGTTQGTVTFGGVTATVKSWTSNRIEVYVPNMAAGLTDVKVTAGGVSSNLYSYNILSGTQTSVVFTVKSAPPTNLGDKIYLTGNIPELGNWSTDTSGAVNNAQGPLLAPNYPDWFYVFSVPAGKTIQFKFFIKRADGTIQWENGSNHVATTPTGATGNITVTWQN

SEQ ID NO: 2 - protein, 491 aa, Bacillus stearothermophilus
AAPFNGTMMQYFEWYLPDDGTLWTKVANEANNLSSLGITALWLPPAYKGTSRSDVGYGVYDLYDLGEFNQKGTVRTKYGTKAQYLQAIQAAHAAGMQVYADVVFDHKGGADGTEWVDAVEVNPSDRNQEISGTYQIQAWTKFDFPGRGNTYSSFKWRWYHFDGVDWDESRKLSRIYKFRGKAWDWEVDTEFGNYDYLMYADLDMDHPEVVTELKNWGKWYVNTTNIDGFRLDAVKHIKFSFFPDWLSYVRSQTGKPLFTVGEYWSYDINKLHNYITKTNGTMSLFDAPLHNKFYTASKSGGAFDMRTLMTNTLMKDQPTLAVTFVDNHDTEPGQALQSWVDPWFKPLAYAFILTRQEGYPCVFYGDYYGIPQYNIPSLKSKIDPLLIARRDYAYGTQHDYLDHSDIIGWTREGVTEKPGSGLAALITDGPGGSKWMYVGKQHAGKVFYDLTGNRSDTVTINSDGWGEFKVNGGSVSVWVPRKTTVSTIARP

SEQ ID NO: 3 - protein, 829 aa, Bacillus acidopullulyticus
DSTSTEVIVHYHRFDSNYANWDLWMWPYQPVNGNGAAYEFSGKDDFGVKADVQVPGDDTQVGLIVRTNDWSQKNTSDDLHIDLTKGHEIWIVQGDPNIYYNLSDAQAAATPKVSNAYLDNEKTVLAKLTNPMTLSDGSSGFTVTDKTTGEQIPVTAATNANSASSSEQTDLVQLTLASAPDVSHTIQVGAAGYEAVNLIPRNVLNLPRYYYSGNDLGNVYSNKATAFRVWAPTASDVQLLLYNSETGPVTKQLEMQKSDNGTWKLKVPGNLKNWYYLYQVTVNGKTQTAVDPYVRAISVNATRGMIVDLEDTNPPGWKEDHQQTPANPVDEVIYEVHVRDFSIDANSGMKNKGKYLAFTEHGTKGPDNVKTGIDSLKELGINAVQLQPIEEFNSIDETQPNMYNWGYDPRNYNVPEGAYATTPEGTARITQLKQLIQSIHKDRIAINMDVVYNHTFNVGVSDFDKIVPQYYYRTDSAGNYTNGSGVGNEIATERPMVQKFVLDSVKYWVKEYHIDGFRFDLMALLGKDTMAKISKELHAINPGIVLYGEPWTGGTSGLSSDQLVTKGQQKGLGIGVFNDNIRNGLDGNVFDKSAQGFATGDPNQVNVIKNGVMGSISDFTSAPSETINYVTSHDNMTLWDKISASNPNDTQADRIKMDELAQAVVFTSQGVPFMQGGEEMLRTKGGNDNSYNAGDSVNQFDWSRKAQFENVFDYYSWLIHLRDNHPAFRMTTADQIKQNLTFLDSPTNTVAFELKNHANHDKWKNIIVMYNPNKTAQTLTLPSGNWTIVGLGNQVGEKSLGHVNGTVEVPALSTIILHQGTSEDVIDQN

SEQ ID NO: 4 - protein, 551 aa, Clostridium thermasulforogenes
MIGAFKRLGQKLFLTLLTASLIFASSIVTANASIAPNFKVFVMGPLEKVTDFNAFKDQLITLKNNGVYGITTDIWWGYVENAGENQFDWSYYKTYADTVRAAGLKWVPIMSTHACGGNVGDTVNIPIPSWVWTKDTQDNMQYKDEAGNWDNEAVSPWYSGLTQLYNEFYSSFASNFSSYKDIITKIYISGGPSGELRYPSYNPSHGWTYPGRGSLQCYSKAAITSFQNAMKSKYGTIAAVNSAWGTSLTDFSQISPPTDGDNFFTNGYKTTYGNDFLTWYQSVLTNELANIASVAHSCFDPVFNVPIGAKIAGVHWLYNSPTMPHAAEYCAGYYNYSTLLDQFKASNLAMTFTCLEMDDSNAYVSPYYSAPMTLVHYVANLANNKGIVHNGENALAISNNNQAYVNCANELTGYNFSGFTLLRLSNIVNSDGSVTSEMAPFVINIVTLTPNGTIPVTFTINNATTYYGQNVYIVGSTSDLGNWNTTYARGPASCPNYPTWTITLNLLPGEQIQFKAVKIDSSGNVTWEGGSNHTYTVPTSGTGSVTITWQN